(19) United States
(12) Patent Application Publication
(10) Pub. No.: US 2009/0151189 A1
(43) Pub. Date: Jun. 18, 2009

(54) Clothes treatment apparatus

(75) Inventors: Jung Wook Moon, Changwon-si (KR); Dae Yun Park, Changwon-si (KR); Sog Kie Hong, Changwon-si (KR); Jong Seok Kim, Changwon-si (KR); Seung Gyu Ryu, Changwon-si (KR); Hye Yong Park, Changwon-si (KR); Chang Gyu Choi, Changwon-si (KR); Dong Won Kim, Changwon-si (KR)

Correspondence Address: MCKENNA LONG & ALDRIDGE LLP, 1900 K STREET, NW, WASHINGTON, DC, 20006, US

(73) Assignee: LG ELECTRONICS INC., Seoul (KR)

(21) Appl. No.: 12/219,948

(22) Filed: Jul. 30, 2008

(30) Foreign Application Priority Data
Aug. 3, 2007 (KR) 10-2007-0078137

(51) Int. Cl. F26B 25/08

(52) U.S. Cl. 34/218

(57) ABSTRACT

A clothes treatment apparatus that treats clothes into a condition suitable to wear is disclosed. The clothes treatment apparatus includes a cabinet, a receiving space defined in the cabinet for receiving clothes, an air supply device for removing moisture from the air so as to provide a dried air to the receiving space, and a fan assembly configured to circulate the dried air in the receiving space and to discharge condensed water generated in the fan assembly to the outside.

### CROSS-REFERENCE TO RELATED APPLICATION

This application claims the benefit of Korean Patent Application No. 10-2007-0078137, filed on Aug. 3, 2007, which is hereby incorporated by reference in its entirety as if fully set forth herein.

### BACKGROUND OF THE INVENTION

1. Field of the Invention

The present invention relates to a clothes treatment apparatus that treats clothes into desired conditions, and more particularly, to a fan assembly applicable to the clothes treatment apparatus.

2. Discussion of the Related Art

Generally, a clothes treatment apparatus is an apparatus that treats clothes into a condition more suitable to wear. Basically, the clothes treatment apparatus is capable of drying clothes. In addition, the clothes treatment apparatus is capable of removing wrinkles, smells, bacteria, and/or static electricity from the clothes.

In order to perform such functions, it is basically necessary to circulate air in a space where clothes are kept, and a fan is generally used to circulate the air.

However, moisture contained in the air passing through the fan is condensed in the fan, and noise may be generated by the condensed water. Also, when the condensed water is left in the fan for a long period of time, bad smells may generated from the condensed water.

### SUMMARY OF THE INVENTION

Accordingly, the present invention is directed to a clothes treatment apparatus that substantially obviates one or more problems due to limitations and disadvantages of the related art.

An object of the present invention is to provide a clothes treatment apparatus that is capable of reducing noise generated during the operation of the clothes treatment apparatus.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a clothes treatment apparatus includes a cabinet, a receiving space defined in the cabinet for receiving clothes, an air supply device for removing moisture from the air so as to provide a dried air to the receiving space, and a fan assembly configured to circulate the dried air in the receiving space and to discharge condensed water generated in the fan assembly to the outside.

Preferably, the fan assembly includes a fan housing, a fan rotatably installed in the fan housing, and a discharge device installed at the fan housing for removing condensed water generated in the fan assembly.

Preferably, the discharge device includes a through-hole formed at the fan housing, and the through-hole is formed at a bottom of the fan housing.

Preferably, the clothes treatment apparatus further includes a sump for storing the condensed water discharged from the air supply device. The discharge device is connected to the sump to discharge condensed water from the fan housing. Also, the fan assembly is disposed such that the through-hole is located higher than the sump.

Preferably, the clothes treatment apparatus further includes a moisture supply device for supplying moisture into the receiving space. The moisture supply device is connected to the sump to discharge condensed water in the moisture supply device.

According to the present invention, the clothes treatment apparatus is capable of reducing noise generated during the operation of the clothes treatment apparatus.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a front view illustrating a clothes treatment apparatus according to the present invention;

FIG. 2 is a perspective view illustrating the internal structure of the clothes treatment apparatus;

FIG. 3 is a perspective view illustrating a fan assembly of FIG. 2; and

FIG. 4 is a schematic view illustrating a condensed water discharge channel of the clothes treatment apparatus.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

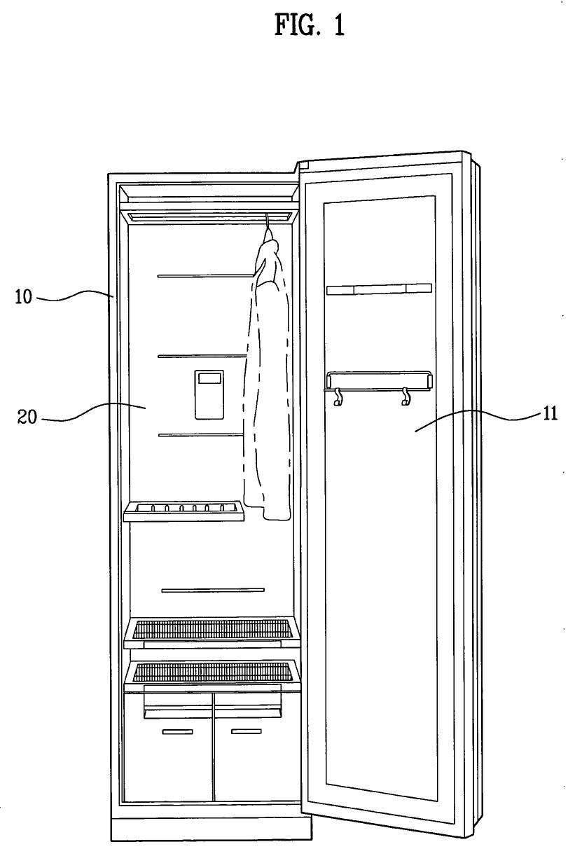

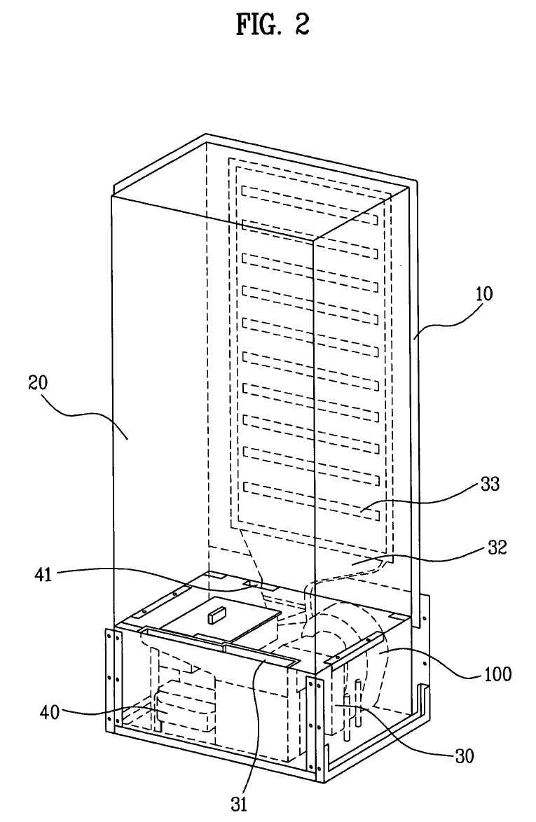

FIG. 1 is a front view illustrating a clothes treatment apparatus according to the present invention, and FIG. 2 is a perspective view illustrating the internal structure of the clothes treatment apparatus illustrated in FIG. 1.

First, a cabinet 10 forms the external appearance of the clothes treatment apparatus according to the present invention. In the cabinet 10 is defined a receiving space 20 for receiving clothes to be treated. Actually, an inner cabinet is provided at the upper portion in the cabinet 10 of the clothes treatment apparatus, and the receiving space 20 is defined in the inner cabinet. Such an inner cabinet is fixed to the cabinet 10, and thus is stationary.

The receiving space 20 may be selectively opened or closed by a door 11 mounted to the cabinet 10 such that the door 11 can be hingedly rotated. Also, various kinds of switches (not shown) for driving the clothes treatment apparatus may be provided at the outside of the cabinet 10.

As shown in FIG. 2, an outfit chamber having a predetermined size is formed below the receiving space 20. In the outfit chamber is basically installed an air supply device 30. The air supply device 30 heats air to supply the heated air, i.e., hot air, into the cabinet 10 and removes moisture from the air. Also, a fan assembly 100 is disposed in the outfit chamber for supplying the air heated and dried by the air supply device 30 into the receiving space 20. Generally, hot air rises upward. Consequently, as shown in the drawing, the structure in which the air supply device 30 is installed below the cabinet 10 is advantageous to the supply of hot air.

The air supply device 30 may include a heater or a thermoelectric element for producing hot and dried air based on the size of the receiving space 20 and a dehumidifier provided separately from the heater or the thermoelectric element. However, it is preferred to use a heat pump that is capable of performing a dehumidifying function as well as the supply of hot air.

The air supply device 30 applied to this embodiment is implemented by a heat pump, which is similar to a heat pump used for air conditioners or the like. That is, the air supply device 30 includes an evaporator, compressor, condenser, and an expansion valve, through which a refrigerant circulates. In this structure, the refrigerant is evaporated by the evaporator to absorb latent heat of surrounding air and to cool the air. By the cooling of the air, moisture in the air is condensed and removed from the air. Also, when the refrigerant is condensed by the condenser after passing through the compressor, the refrigerant discharges latent heat to surrounding air to heat the air. Consequently, the evaporator and the condenser function as a heat exchanger, with the result that air introduced into the air supply device 30 changes into dry and hot air after passing through the evaporator and the condenser.

The temperature of the air heated by the heat pump as described above may be somewhat lower than that of air heated by the conventional heater; however, the air heated by the heat pump may be dehumidified without using an additional dehumidifier. Consequently, the hot and dried air generated by the air supply device 30 can effectively dry the clothes in the receiving space, with the result that the clothes are refreshed into a condition suitable to wear.

More specifically, a suction port 31 is formed at the bottom of the receiving space 20. Consequently, air in the receiving space 20 is introduced into the air supply device 30 through the suction port 31. The introduced air is heated and dehumidified in the air supply device 30, and is then fed to a duct 32 by the fan assembly 100. Finally, the dry and hot air is supplied into the receiving space 20 through discharge ports 33.

Meanwhile, the clothes treatment apparatus may include a moisture supply device 40 installed in the outfit chamber in the same manner as the air supply device 30. The moisture supply device 40 generates moisture and provides generated moisture to the receiving space 20. The moisture supply device 40 could use a mist which comprises fine droplets of water in a liquid phase or a steam which is a vapor phase of water, to moisturizing the receiving space 110. The present application describes the moisture supply device 40 using the steam in the followings. However, the moisture supply device 40 using the mist could be applied to the clothes treatment apparatus for the same purpose. The moisture supply device 40 is configured to selectively supply steam into the receiving space 20. The moisture supply device 40 basically includes a heater for heating water to generate steam and a nozzle for supplying the generated steam into the receiving space 20. A water supply source of the moisture supply device 40 may be implemented by an external faucet or a container installed in the outfit chamber for storing a predetermined amount of water. The container is preferably separably installed in the outfit chamber. Consequently, it is possible for a user to take the container out of the outfit chamber to fill the container with water. As shown in FIG. 2, the generated steam is supplied into the receiving space 20 through a discharge port 41 formed at the bottom of the receiving space 20.

Wrinkles and/or static electricity may be removed from the clothes by the steam supplied into the receiving space 20. Also, the high-temperature steam may remove bacteria and/or smells from the clothes. Consequently, the moisture supply device 40 can refresh the clothes into a condition suitable to wear. The point of time when the steam is supplied may be appropriately changed. When the hot air is supplied after the high-temperature steam is sprayed, the clothes may be completely dried, with the result that moisture may be completely removed from the clothes. Consequently, it is preferred to spray the steam before the hot air is supplied by the air supply device 30.

Meanwhile, as previously described, the circulation of the hot and dried air is achieved by the fan assembly 100. More specifically, the fan assembly 100 is installed adjacent to the air supply device 30 for suctioning the air heated by the air supply device 30 and discharging the suctioned air to the receiving space 20 to circulate the air. Hereinafter, the fan assembly 100 will be described in more detail with reference to the relevant drawing.

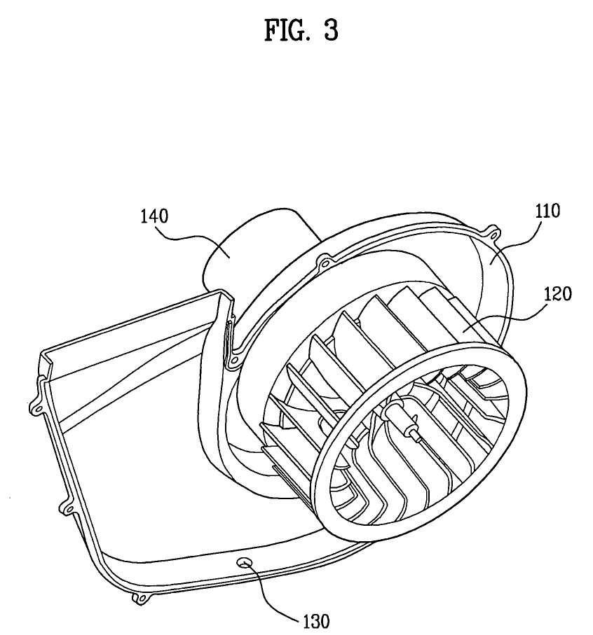

Referring to FIG. 3, the fan assembly 100 basically includes a fan housing 110 forming the external appearance of the fan assembly and a fan 120 rotatably installed in the fan housing 110. The fan 120 is rotated by a drive unit 140 to discharge suctioned air in a predetermined direction. The fan housing 110 forms the external appearance of the fan assembly 100 to protect components, such as the fan 120 and the drive unit 140, installed in the fan housing 110. In conclusion, the fan assembly 100 suctions air in front of the fan assembly and discharges the suctioned air along a flow channel defined in the fan housing 110. By this configuration, therefore, it is possible to control the discharge direction through the use of the fan housing 110.

Generally, the fan assembly 100 is made of a member exhibiting low thermal conductivity, and therefore, the fan assembly 100 is maintained at surface temperature lower than the hot air. For this reason, when high-temperature air containing moisture passes through the fan assembly 100, moisture may be condensed due to the low surface temperature. In particular, the flow channel defined by the fan housing 110 has a large surface area, and therefore, condensed water may be easily generated. When condensed water is generated in the fan assembly 100 as described above, the condensed water collides with the fan 120, which is rotated at high speed, with the result that noise may be generated. Also, the condensed water may corrode the fan assembly 100 or emit bad smells. For this reason, the fan assembly 100 includes a discharge device 130 for discharging the condensed water generated in the fan assembly 100 to the outside.

As previously described, the fan housing 110 comes into the widest contact with the hot air, with the result that most condensed water is generated in the fan housing 110. Also, the condensed water generated on the fan 120 is dispersed by the rotation of the fan 120, with the result that the condensed water from the fan 120 gathers in the fan housing 110. For this reason, the discharge device 130 is disposed in the fan housing 110. More specifically, the discharge device 130 may include a through-hole formed in the fan housing 110. When the size of the discharge device 130 is large, hot air as well as condensed water may be discharged to the outside through the discharge device 130. When the discharge device 130 is formed in the shape of a through-hole, therefore, it is possible for the discharge device 130 to perform an intended function without the discharge of the hot air even in the simplest structure. Also, the through-hole 120 is more preferably formed at the bottom of the fan housing 110. This is because the condensed water gathers at the bottom of the fan housing 110 by its own weight. More preferably, the lower part of the fan housing 110 is formed in a downward convex shape such that the condensed water can easily gather at the bottom of the fan housing 110 where the through-hole 130 is located. Also, when the lower part of the fan housing 110 is formed in the downward convex shape, friction between the hot air and the fan housing 110 may decrease.

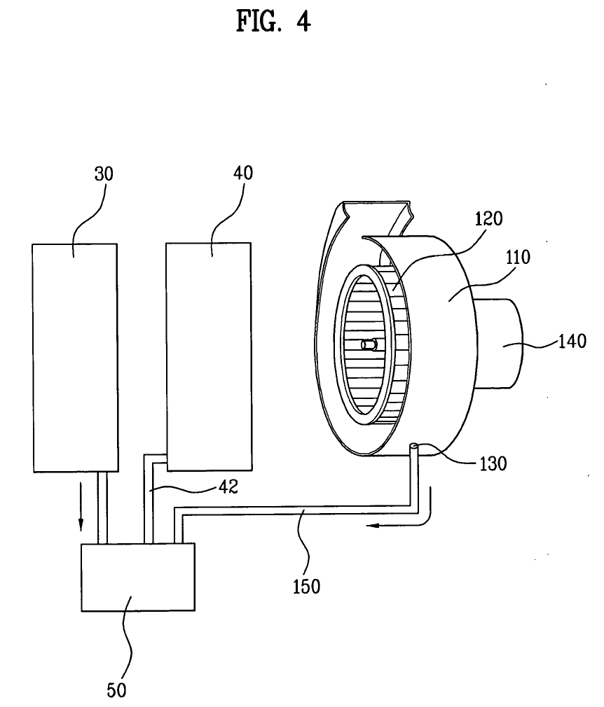

FIG. 4 is a schematic view illustrating a condensed water discharge channel of the fan assembly 100.

As previously described, the air supply device 30 performed a dehumidifying function using the evaporator, with the result that a considerable amount of condensed water is generated. For this reason, the clothes treatment apparatus according to the present invention may further include a sump 50 for storing the condensed water discharged from the air supply device 30. In this case, the structure of the clothes treatment apparatus may be complicated by the use of an additional sump with respect to the condensed water of the fan assembly 100. For this reason, it is preferred for the sump 50 to be jointly used by the air supply device 30 and the fan assembly 100. In this structure, the condensed water generated from the fan assembly 100 is discharged to the sump 50 through the through-hole 130. More specifically, as shown in FIG. 4, a pipe 150 is connected between the through-hole 130 and the sump 50. Consequently, the condensed water is discharged to the sump 50 through the pipe 150. Also, since the moisture supply device 40 are heated to high temperature, condensed water may be generated on the moisture supply device 40 due to the difference in temperature between the moisture supply device and the surroundings. For the same reason, therefore, the condensed water from the moisture supply device 40 may be also discharged to the sump 50 through a pipe 42. The condensed water stored in the sump 50 may be discharged out of the clothes treatment apparatus later on. As previously described, the hot air and moisture supply devices 30 and 40 and the fan assembly 100 may jointly use the single sump 50 to discharge the condensed water. The joint use of the sump 50 simplifies the manufacturing process of the clothes treatment apparatus and thus reduces the manufacturing costs of the clothes treatment apparatus.

In the fan assembly 100, it is preferred for the through-hole 130 to be located above the sump 50. When the through-hole 130 is located above the sump 50, it is possible to naturally discharge the condensed water to the sump 50 through the pipe 150 without the use of an additional component, such as a pump. Also, when the fan assembly 100 is located above the sump 50 such that the sump 50 is disposed right below the fan assembly 100, the condensed water drops to the sump 40 directly through the through-hole although the pipe 150 is not provided.

As apparent from the above description, the clothes treatment apparatus according to the present invention prevents condensed water generated in the fan assembly from remaining in the fan assembly through the use of the discharge device. Consequently, the present invention has the effect of minimizing noise generated during the operation of the clothes treatment apparatus and preventing the emission of bad smells from the remaining condensed water. Also, the components of the clothes treatment apparatus jointly use the single sump to discharge the condensed water. Consequently, the present invention has the effect of simplifying the structure of the clothes treatment apparatus, thereby simplifying the manufacturing process of the clothes treatment apparatus and reducing the manufacturing costs of the clothes treatment apparatus.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A clothes treatment apparatus comprising:
a cabinet;
a receiving space defined in the cabinet for receiving clothes;
an air supply device for removing moisture from the air so as to provide a dried air to the receiving space; and
a fan assembly configured to circulate the dried air in the receiving space and to discharge condensed water generated in the fan assembly to the outside.

2. The clothes treatment apparatus according to claim 1, wherein the fan assembly comprises:
a fan housing;
a fan rotatably installed in the fan housing; and
a discharge device installed at the fan housing for removing condensed water generated in the fan assembly.

3. The clothes treatment apparatus according to claim 2, wherein the discharge device includes a through-hole formed at the fan housing.

4. The clothes treatment apparatus according to claim 3, wherein the through-hole is formed at a bottom of the fan housing.

5. The clothes treatment apparatus according to claim 2, further comprising:
a sump for storing the condensed water discharged from the air supply device.

6. The clothes treatment apparatus according to claim 5, wherein the discharge device is connected to the sump to discharge condensed water from the fan housing.

7. The clothes treatment apparatus according to claim 5, wherein the fan assembly is disposed such that the through-hole is located higher than the sump.

8. The clothes treatment apparatus according to claim 1 or 5, further comprising:
a moisture supply device for providing moisture into the receiving space.

9. The clothes treatment apparatus according to claim 8, wherein the moisture supply device is connected to the sump to discharge condensed water in the moisture supply device.
